(19) United States
(12) Patent Application Publication
(10) Pub. No.: US 2007/0282962 A1
(43) Pub. Date: Dec. 6, 2007

(54) Auto-Subscribing to Syndication Feeds Using Contact Lists

(75) Inventors: Jane T. Kim, Seattle, WA (US); Michael I. Torres, Seattle, WA (US); Michael C. Connolly, Seattle, WA (US); Ojiakonobi Udezue, Redmond, WA (US); Anthony G. Thane, Redmond, WA (US); Geurt B. De Raad, Sammamish, WA (US); Christopher J. Beiter, Seattle, WA (US); Daniel S. Struthers, Federal Way, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/421,703

(22) Filed: Jun. 1, 2006

(51) Int. Cl. G06F 15/16

(52) U.S. Cl. 709/207

(57) ABSTRACT

An application executes on a client device to automatically subscribe a user to a particular syndication feed. In at least some instances, the user can be preliminarily unaware that they have been subscribed to the feed. In at least some embodiments, the application automatically subscribes to feeds using one or more contact lists that contain contacts that are relevant to the particular user. Specifically, the application is able to access the contact list(s) and ascertain from the individual contacts who, among the user's contacts, constitutes a source of a syndication feed. Once one or more contacts have been identified, the application can automatically subscribe to the feed so that the user can now receive and consume feed data.

### BACKGROUND

Syndication feeds, such as RSS (Really Simple Syndication) feeds, provide a powerful way for individuals to publish content, such as blogs, images and the like. When subscribed to, a syndication feed can provide subscribers with a rich amount of timely content. Yet, it appears that a large percentage of the relevant consuming market is either unaware of such syndication feeds, apprehensive to subscribe to such feeds, or simply does not know how to subscribe to particular feeds.

Accordingly, a presumably large portion of the potential consuming market remains untapped.

### SUMMARY

Various embodiments described below permit an application that executes on a client device to automatically subscribe a user to a particular syndication feed. In at least some instances, the user can be preliminarily unaware that they have been subscribed to the feed. In at least some embodiments, the application automatically subscribes to feeds using one or more contact lists that contain contacts that are relevant to the particular user. Specifically, the application is able to access the contact list(s) and ascertain from the individual contacts who, among the user's contacts, constitutes a source of a syndication feed. Once one or more contacts have been identified, the application can automatically subscribe to the feed so that the user can now receive and consume feed data.

### BRIEF DESCRIPTION OF THE DRAWINGS

FIG. 1 illustrates an exemplary environment, in accordance with one embodiment, in which the inventive embodiments can be employed.

FIG. 2 illustrates portions of the FIG. 1 system in accordance with one embodiment.

FIG. 3 is a flow diagram that describes steps in a method in accordance with one embodiment.

### DETAILED DESCRIPTION

Overview

Various embodiments described below permit an application that executes on a client device to automatically subscribe a user to a particular syndication feed. In at least some instances, the user can be preliminarily unaware that they have been subscribed to the feed. In at least some embodiments, the application automatically subscribes to feeds using one or more contact lists that contain contacts that are relevant to the particular user. Specifically, the application is able to access the contact list(s) and ascertain from the individual contacts who, among the user's contacts, constitutes a source of a syndication feed. Once one or more contacts have been identified, the application can automatically subscribe to the feed so that the user can now receive and consume feed data.

One motivation for using a user's contact list as a source for automatic feed subscriptions is that by virtue of appearing on a user's contact list, an assumption is made that the contact is important, in some way, to the particular user. This being the case, another assumption is that such a user would be interested in this feeds from that contact.

In the discussion that follows, particular examples of applications, contact lists and syndication feeds are utilized. It is to be appreciated and understood that these constitute but examples and are not intended to limit application of the claimed subject matter to only those specific examples that are used in this document. For example, in the discussion that follows, syndication feeds in the form of RSS feeds, and a specific instance of such a feed—a web log or “blog”—are used to describe the inventive embodiments. Other syndication feeds and other different instances of such feeds can be used without departing from the spirit and scope of the claimed subject matter.

In the discussion that follows, a section entitled “Exemplary Environment” provided and describes an environment in which the inventive embodiments can be employed. Following this, a section entitled “Automatically Subscribing to a Feed” is provided and describes examples of how the inventive embodiments can automatically subscribe to a feed. In addition, this section includes several sub-sections that describe various features that can be utilized in connection with the feed subscription process. Lastly, a section entitled “Implementation Example” is provided and describes but one specific implementation that embodies several of the inventive notions that were described in previous sections.

Exemplary Environment

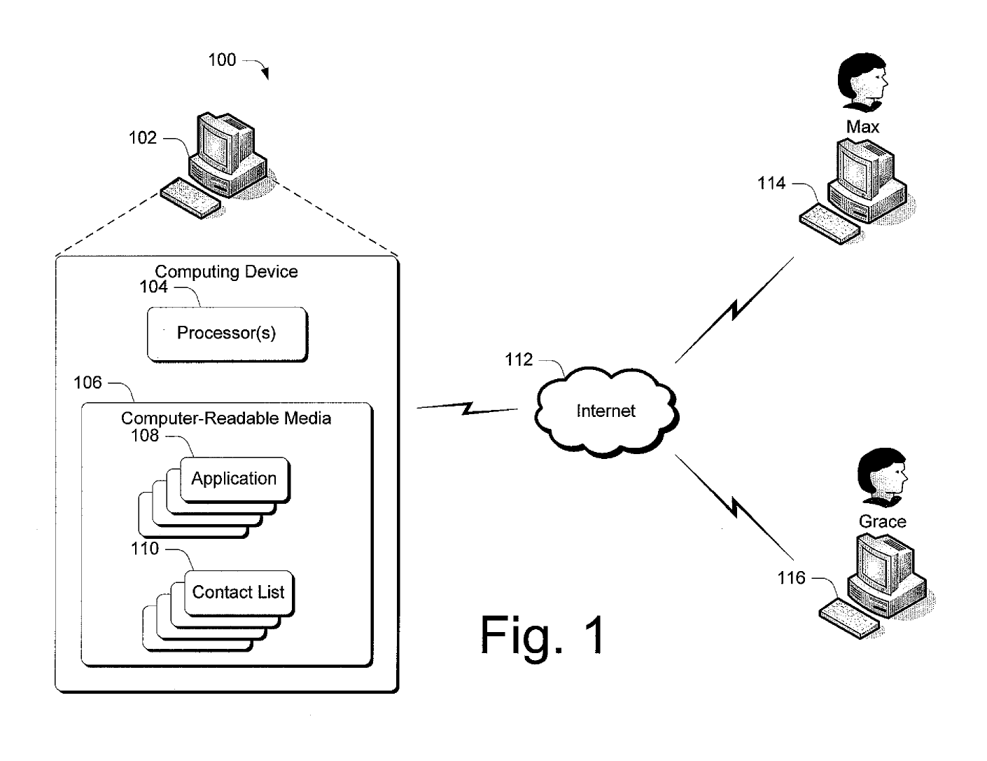

FIG. 1 illustrates an exemplary environment, in accordance with one embodiment, in which the inventive embodiments can be employed, generally at 100.

Here, system 100 includes a client computing device 102 which includes one or more processors 104 and one or more computer-readable media 106 on which executable, computer-readable instructions reside. In this example, computer-readable media 106 includes code that implements one or more applications 108. The various embodiments described below can be implemented by any suitable type of application. Examples of applications that can be used to implement the inventive features described herein include, by way of example and not limitation, email applications or clients, instant messaging applications or clients and the like. It is to be understood that other applications can be utilized without departing from the spirit and scope of the claimed subject matter.

In addition, computer-readable media 106 includes or device 102 otherwise has access to one or more contact lists 110 that include information and properties associated with a user's contacts. For example, email applications typically have a contact list of individuals to and from whom an individual sends and receives emails. Likewise, an instant messaging application typically allows a user to keep a contact list in the form of a “buddy list” that describes individuals with whom a user conducts instant messaging activities. Alternately or additionally, many organizations maintain an intranet contact list of individuals that are members of the organization.

Computing device 102 is configured to communicate with other computing devices by way of a network which, in this example, resides in the form of the Internet 112. Other networks can be utilized without departing from the spirit and scope of the claimed subject matter. In this example, two individuals who appear on a contact list 110 are shown respectively at 114 (i.e. Max) and 116 (i.e. Grace). Thus, in this example, a user of computing device 102 has included both Max and Grace on one or more of their relevant contact lists.

As will become apparent below, a user's contact list or lists can serve as the basis by which syndication feeds are automatically subscribed to for the user.

It is to be appreciated and understood that while the computing devices in the FIG. 1 example are illustrated as desktop devices, such devices can take other forms such as laptop or notebook computers, handheld computers, or any other type of computing device.

Automatically Subscribing to a Feed

As noted above, the various embodiments described in this document can be implemented in connection with any suitable application or applications, such as an email application and/or an instant messaging application.

Email applications typically allow individuals to send email messages to other individuals. Because the operation of email applications is generally understood, such applications are not described in greater detail here.

Instant messaging applications tend to be less understood, so the following discussion is provided to give the reader some additional background on instant messaging applications.

Generally, instant messaging applications allow users to instantly communicate and collaborate with what are termed their “contacts” or “buddies”. A user can build a list of contacts or buddies by providing a friendly name such as “Paul” and an address. Instant messaging applications utilize the notion of “presence”, which makes instant communication and collaboration with contacts even more effective. Presence gives users the ability to find each other and stay constantly updated with each other's online status. The powerful capabilities of presence are usually provided through a presence-based network that utilizes one or more servers or services, as will be appreciated by the skilled artisan.

The protocol used for initialization and communication on an instant messaging session depends upon the server or service being used. For example, text can be carried over a TCP connection, a TCP UDP or Secure Sockets Layer (SSL), to name just a few. Typically, an initiating client sends a request to start a conversation with the contact to the server, which is then forwarded to the other client. The instant messaging communication can then proceed. Specifically, message text can now be sent to the server and forwarded to the other client. How the message text is delimited depends upon the server and protocols being used. In some systems, text is sent using a Hypertext Transfer Protocol (HTTP) or Extensible Markup Language (XML) in HTTP message encapsulated in the TCP connection with the server. Other features that instant messaging applications can provide include, by way of example and not limitation, voice and video calls, application sharing and file transfer, all of which will be appreciated by the skilled artisan.

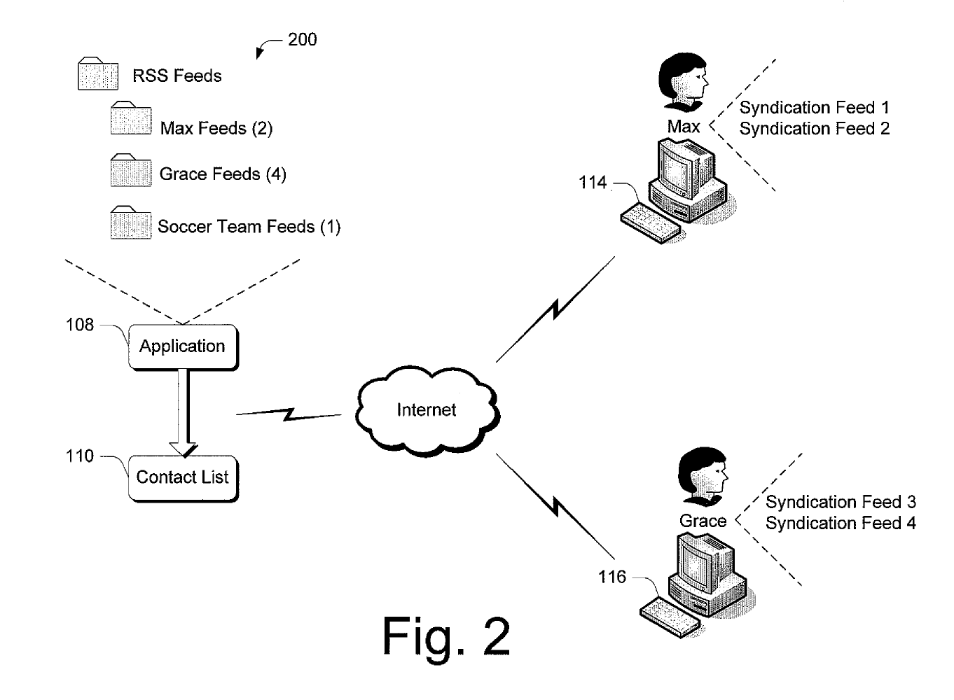

FIG. 2 illustrates portions of the FIG. 1 system in accordance with one embodiment. Here, application 108, such as an email application or an RSS reader application has been launched by the user. In accordance with one embodiment, when the application is launched, one or more contact lists, such as contact list 110 enumerated. Contacts on the contact list that serve as a source of a syndication feed, such as a blog, are identified and the user is automatically subscribed to the associated syndication feed which, in this example, comprises a blog that is delivered through RSS. Techniques for subscribing to a syndication feed are well known and are not described in great detail here. In some subscription scenarios, a syndication platform, e.g. an RSS platform, can be utilized to facilitate the subscription process. Typically, such a platform can be supported and exposed by a third party server or service. Such platforms can be configured to perform a number of different subscription and synchronization-related activities such as receiving and processing subscription requests, receiving and processing synchronization requests, and the like.

When the user is automatically subscribed to a feed, the individual feeds are presented to the user automatically, so that the user can consume the feed in a familiar fashion. For example, in one embodiment, application 108 is an email application and the feeds that are subscribed to are presented to the user in a folder structure within the context of the email application. One such folder structure is shown generally at 200. Here, a root folder called “RSS Feeds” is created in the user's email directory. Underneath this folder, additional folders appear—one designated “Max Feeds”, one designated “Grace Feeds”, and one designated is “Soccer Team Feeds”. Each folder includes, in this example, a parenthetical indication of feed items that have not been read. In this case, there are two items in Max's feed that the user has not read, there are four items in Grace's feed that the user has not read, and there is one item in the Soccer Team feed that the user has not read.

It should be appreciated and understood that individuals can be subscribed to feeds from not only other individuals, but from groups or circles of which they are a member. A group or circle is, in this example, a persistent group of people who all agree that they are members of the group. In a user's contact list, a group or circle serves as a contact and is a peer of a contact, even though it contains other contacts. Each group or circle also has a space in which members may contribute such things as photo albums, blogs and boards. In this example, then, a user can be automatically subscribed to circle space feeds and the like.

In this manner, the user is automatically subscribed to the feed and can consume feed data in the context of an application that is familiar to them—the email application. In this way, novice users who may not necessarily be versed in the nuances of syndication feeds can, nonetheless, be exposed to the richness and robustness that such feeds provide.

Using Filters to Filter Feeds

In some instances, it may be desirable to filter the feeds that are identified for subscription. For example, a user may have a large number of contacts in their contact list, each of which may be the source of a large number of feeds. In this instance, automatically subscribing to feeds from each of the contacts may prove unwieldy. In this case as well as others, it may be advantageous to allow the user to set up a filter that defines criteria according to which subscription activities are to occur.

Any suitable filter or type of filter can be used. For example, a filter might be defined to include feeds only from contacts that appear on the user's instant messaging buddy list. Alternately or additionally, a filter might be set up based on the frequency with which the user communicates with a contact. That is, those contacts that are communicated with more frequently may have their feeds (such as blog feeds or personal feeds) subscribed to, while those contacts that are not communicated with frequently may not have their feeds subscribed to. Any other criteria can be used to define a filter. For example, a filter might be constructed that identifies important contacts as those for whom the user has personal contact properties, such as home phone number, cell phone number, or if the user has peer-to-peer file sharing privileges.

Needless to say, the filtering possibilities are potentially endless.

Auto-Synchronizing the Subscription List with Contact Changes

In at least some embodiments, the subscription list can be auto-synchronized in accordance with changes that occur to the user's contacts. For example, events such as adding a contact or an RSS URL to a contact's information, changing an RSS URL, and/or deleting contacts or RSS URLs can all be used to spawn an auto-synchronization event.

This can enable the user's application to detect and present, for example, new blogs such that the blogs that the user receives are never stale.

Auto-populating the “FROM:” Field

Given the state of the RSS standard, as will be appreciated by the skilled artisan, it is not always possible to ascertain the name of an individual who serves as the source of a particular feed. That is, the feed may have a feed name which does not necessarily indicate or imply the contact that serves as the source of the feed.

In at least one embodiment, the “FROM” field of the items that appear in the user's email client and which correspond to a particular feed is automatically populated with, for example, a corresponding email address and/or name. That is, by virtue of having automatically subscribed, using a contact list, to a particular contact's feed, the client-side application is knowledgeable of the information that appears in the properties of that particular contact. Such properties can and typically do include an associated email address and/or contact name. If this is the case, the client-side application can simply populate this information into the appropriate field of the message that is presented to the user.

Auto-Synchronizing on a Feed Change

RSS systems tend to synchronize on a fixed schedule in which an appropriate source of the RSS feed is polled by the client wishing to receive an update. This means that there will be times when clients may have stale data. Specifically, if an RSS source updates its information just after being polled by a particular client, this client's data will be stale until the next polling interval.

In at least one embodiment, changes to a contact's feed are pushed to the user whenever the changes take place. In this manner, the user can receive fairly timely updates. As but one example of how this can be implemented, consider the following. In Microsoft's Live Messenger (Microsoft's version of an instant messaging application), there is infrastructure in place that implements push notifications for some contact property changes in order for compliance with some operating requirements of Messenger. These push notifications typically take place in the form of what is referred to as a gleam that appears on a user's Messenger user interface. In a manner similar to that which is employed in this context, specific changes to a contact's RSS URL can invoke a push notification to the user which, in turn, can invoke the auto-synchronization functionality.

Friends of Friends

In one embodiment, a user can not only be auto-subscribed to the feeds of their relevant contacts, but they can also be subscribed to feeds to which their contacts are subscribed. Specifically, when the client side application auto-synchronizes to a particular contact's feed it can ascertain, through an API call to the contact's application, which feeds the contact is subscribed to. Once this information is ascertained, the user's client side application can subscribe to feeds to which his contact is subscribed as well.

Rated Feeds

In some embodiments, feeds can be subscribed to based upon some type of rating criteria. For example, a user may employ a star rating system in which feeds with a higher number of stars are automatically subscribed to, while feeds having a lower number of stars are not subscribed to. In at least some embodiments, ratings can be assigned either by the user or automatically, using a number of different possible criteria. For example, a feed may have its rating automatically increased when a user has more frequent contact with an associated contact, or when a feed includes newer content.

Implementation Example

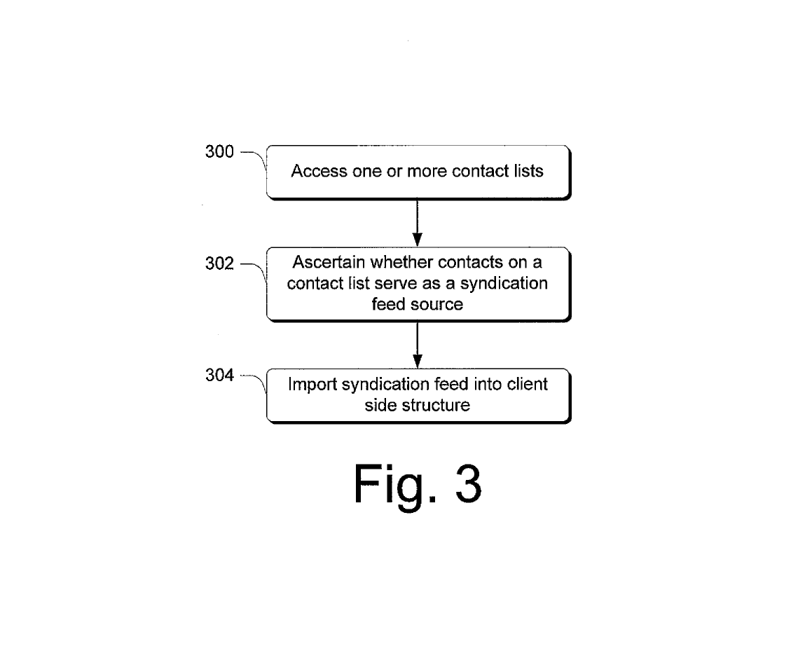

FIG. 3 is a flow diagram that describes steps in a method in accordance with one embodiment. The method can be implemented in connection with any suitable hardware, software, firmware or combination thereof. In one embodiment, the method is implemented using one or more client-side applications. In one particular implementation, the method is implemented using one or more of an email application, RSS reader application or an instant messenger application.

Step 300 accesses one or more contact lists. Any suitable contact list can be utilized. In one embodiment, this step can be performed when the user launches their email client or RSS reader for the first time. Alternately or additionally, this step can be implemented at other times, such as whenever a user launches their email client or RSS reader.

Step 302 ascertains whether contacts on a contact list serve as a syndication feed source. This step can be performed in any suitable way using any suitable syndication feed source. For example, in one embodiment, all of the contacts in the contact list can be enumerated and their properties can be examined to ascertain whether any of the individual properties refer to a syndication URL. Alternately or additionally, the contacts can each have a unique identifier. This unique identifier can be used as the basis for a call to a server that includes mappings of identifiers to syndication feeds identified with the identifier. For example, in the instant messaging space, a contact's identifier in conjunction with the presence-based network and information maintained by the presence-based network can be utilized to ascertain whether the contact is associated with a syndication feed. Alternately or additionally, a user's contact may have previously published a syndication URL to the user such that the user's system is already aware of a syndication feed associated with that contact. In addition, any suitable syndication feed can be the subject of this step. As noted above, one example of a syndication feed type is RSS. Further, one instance of such a feed is a blog that is delivered using instrumentalities of RSS.

Step 304 imports an associated syndication feed into a client side structure for the user. That is, once one or more syndication feeds have been ascertained to be associated with one or more of the user's contacts, the user can be automatically subscribed to the feed. Any suitable structure can be utilized to present feed contents to the user. In one example above, the client side structure that is used is an email-centric folder system. Of course, other structures can be utilized without departing from the spirit and scope of the claimed subject matter.

Extensions

In at least some embodiments, a user can be auto-subscribed to various feeds based on, for example, a context-sensitive search pane. For example, data-mining techniques can be used to mine emails, news and RSS items to then scope a context search to blogs or feeds that contain content that is similar with that identified in the data mining.

Conclusion

Various embodiments permit an application that executes on a client device to automatically subscribe a user to a particular syndication feed. In at least some instances, the user can be preliminarily unaware that they have been subscribed to the feed. In at least some embodiments, the application automatically subscribes to feeds using one or more contact lists that contain contacts that are relevant to the particular user. Specifically, the application is able to access the contact list(s) and ascertain from the individual contacts who, among the user's contacts, constitutes a source of a syndication feed. Once one or more contacts have been identified, the application can automatically subscribe to the feed so that the user can now receive and consume feed data.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
ascertaining, from one or more contact lists, individual contacts that constitute a source of a syndication feed; and
automatically subscribing a user to one or more syndication feeds responsive to said act of ascertaining.

2. The method of claim 1, wherein at least one of said one or more contact lists comprises the user's contact list.

3. The method of claim 2, wherein said contact list comprises an email contact list.

4. The method of claim 2, wherein said contact list comprises an instant messaging buddy list.

5. The method of claim 1, wherein said syndication feed comprises an RSS feed.

6. The method of claim 1, wherein said syndication feed is associated with a blog.

7. A computer-implemented method comprising:
ascertaining, from one or more contact lists, individual contacts that constitute a source of an RSS feed;
automatically subscribing a user to one or more RSS feeds responsive to said act of ascertaining; and
presenting, to the user, a client side structure from which subscribed feeds can be consumed by the user.

8. The method of claim 7, wherein the client side structure comprises a folder structure.

9. The method of claim 8, wherein said act of presenting is performed by providing an individual folder for each contact that serves a source of an RSS feed.

10. The method of claim 7, wherein the client side structure comprises a folder structure, and wherein said act of presenting is performed by an email application.

11. The method of claim 7, wherein at least one RSS feed comprises a blog.

12. The method of claim 7 further comprising filtering RSS feeds that have been identified for subscription.

13. The method of claim 7 further comprising automatically synchronizing a RSS feed subscription list in accordance with changes that occur to the user's contacts.

14. The method of claim 7, wherein the act of presenting comprises automatically populating a field associated with a particular RSS feed, with a name or email address of the source of the RSS feed.

15. The method of claim 7 further comprising automatically synchronizing a RSS feed based on a change that has been made to the RSS feed.

16. The method of claim 7 further comprising automatically subscribing to one or more RSS feeds that are received by one or more contacts that appear in said one or more contact lists.

17. The method of claim 7 further comprising subscribing to one or more RSS feeds based on rating criteria.

18. The method of claim 7, wherein at least one of said one or more contact lists comprises the user's contact list.

19. The method of claim 18, w herein said contact list comprises an email contact list.

20. The method of claim 18, wherein said contact list comprises an instant messaging buddy list.
